(19) United States
(12) Patent Application Publication
(10) Pub. No.: US 2012/0110970 A1
(43) Pub. Date: May 10, 2012

(54) MOWER BLADE WITH REPLACEABLE INSERTS

(76) Inventor: JAMES A. BLAREK, Hatley, WI (US)

(21) Appl. No.: 12/939,830

(22) Filed: Nov. 4, 2010

(51) Int. Cl. A01D 34/52

(52) U.S. Cl. 56/295

(57) ABSTRACT

The mower blade with replaceable inserts includes a blade bar having diametrically opposite reliefs therein for replaceable cutting inserts. Headed pins extend from each relief, and each insert has corresponding slots. The slots have larger diameter outer ends to clear the larger diameter heads of the pins, the inner portions of the slots being stepped to fit closely about the narrower shanks of the pins. The inserts drop into position over the corresponding pins, and slide outwardly to be retained by the heads of the pins. The outer (lower) surfaces of the heads of the pins are coplanar with the outer (lower) surfaces of the inserts when installed. The cutting edge portions of the inserts extend over and are in direct contact with the corresponding leading edge portions of the blade bar, thus protecting the bar and transferring impact forces directly to the bar rather than through the pins.

### BACKGROUND OF THE INVENTION

1. Field of the Invention

The present invention relates generally to the cutting and trimming of vegetation, and particularly to a mower blade with replaceable inserts that serve as the cutting elements of the blade, and that may be removed from and replaced upon the blade bar without extensive need of tools.

2. Description of the Related Art

Powered rotary lawnmowers and the like conventionally have a single rotating blade bar powered by a prime mover (reciprocating internal combustion engine, electric motor, etc.). The blade bar is conventionally provided with cutting edges as integral components of the blade. When these cutting edges become dulled, it is necessary to remove the blade bar from the mower in order to sharpen the cutting edges. This can be a difficult chore, as the blade bar is typically secured tightly to the shaft of the prime mover to prevent it from loosening due to engine vibration, striking an object, or other causes. The blade bar must be blocked in some manner to prevent it from turning while considerable torque is applied to the retaining nut to remove it and thus remove the bar.

Accordingly, a number of replaceable cutting elements or inserts have been developed in the past, allowing those elements or inserts to be removed and replaced without the need to remove the entire blade bar from the mower. Many such assemblies require the extensive use of tools, however, thus providing little if any advantage over the conventional blade bar having integral cutting edges. Moreover, all such assemblies with removable cutting elements or inserts have downwardly protruding fasteners or fastener heads that frequently impact the underlying surface and/or become contaminated with debris. The removal of these fasteners is often a difficult process when they are damaged due to impact, or when debris has become compacted around the protruding fastener. Such protruding fasteners are also prone to being ground away if the mower is used extensively along concrete curbs, raised stone walkways, and similar structures. If the heads of such fasteners are ground away due to wear, the cutting elements are no longer held in place and will be flung from the blade bar with considerable force when the mower is in normal operation. Obviously, this is extremely hazardous. In addition, the typical replaceable cutting element or insert leaves the leading edge of the blade bar exposed, which often results in damage to the blade bar itself and the jamming of material between the blade bar and the cutting element or insert. Also, the fasteners themselves often take the entire impact load when such a removable cutting element or insert strikes an object, rather than the load being transferred directly to the more durable blade bar.

Thus, a mower blade with replaceable inserts solving the aforementioned problems is desired.

### SUMMARY OF THE INVENTION

The mower blade with replaceable inserts includes a blade bar having diametrically opposite reliefs formed therein for the removable installation of cutting inserts. A plurality of headed pins extends downwardly from the floor of each relief, the pins serving to secure the cutting inserts removably to the blade bar. Each insert has a corresponding plurality of elongate slots therein, the outboard ends of the slots (the ends away from the center of rotation of the blade bar) having circular passages large enough to clear the larger heads of the retaining pins. The remainder of each slot has a narrower portion that fits closely about the narrower shank of the corresponding pin, and an outwardly stepped wider portion that fits closely about the wider head of the pin. Thus, the cutting insert may be placed over the heads of the retaining pins and slid outwardly so that the stepped portion of each slot is captured beneath the head of the corresponding retaining pin. The surfaces of the heads of the pins and the outer, downwardly facing surfaces of the corresponding cutting inserts are coplanar with one another, thus precluding (or at least greatly reducing) the capture of debris by the assembly.

The sharpened cutting edge portion of each insert has a face that extends upwardly and rearwardly (from the direction of rotation of the blade bar) to the upper surface of the blade bar. This protects the leading edge of the blade bar from damage due to impact or other causes. The replaceable cutting insert absorbs any impact damage, instead. The back of the cutting edge portion is in direct contact with the leading edge of the blade bar. This serves to transfer any impact forces directly to the blade bar, rather than through the insert attachment pins. Moreover, the extremely close fit between the cutting insert and the blade bar precludes (or at least greatly reduces) the capture of debris therebetween, thus making it far easier to remove and replace the cutting inserts and to maintain the blade bar and cutting insert assembly.

These and other features of the present invention will become readily apparent upon further review of the following specification and drawings.

### BRIEF DESCRIPTION OF THE DRAWINGS

FIG. 1 is a bottom perspective view of a mower blade with replaceable inserts according to the present invention, showing one cutting insert installed and the opposite insert separated from the blade bar.

FIG. 2 is a top perspective view of the mower blade of FIG. 1, showing both inserts installed on the blade bar.

FIG. 3 is a partial bottom view of one end of the mower blade of FIGS. 1 and 2, showing the relief in the blade for the installation of an insert.

FIG. 4 is a partial bottom view of the mower blade of FIG. 3, showing an insert installed in the relief.

FIG. 5 is a partial elevation view in section of the mower blade of FIG. 4, showing further details of attachment of the insert to the blade bar.

Similar reference characters denote corresponding features consistently throughout the attached drawings.

### DETAILED DESCRIPTION OF THE PREFERRED EMBODIMENTS

The mower blade with replaceable inserts comprises a blade bar having diametrically opposed cutting inserts removably attached thereto. The inserts are quickly and easily removed as required for sharpening or exchange, and may be quickly and easily reinstalled without need to remove the blade bar from the mower.

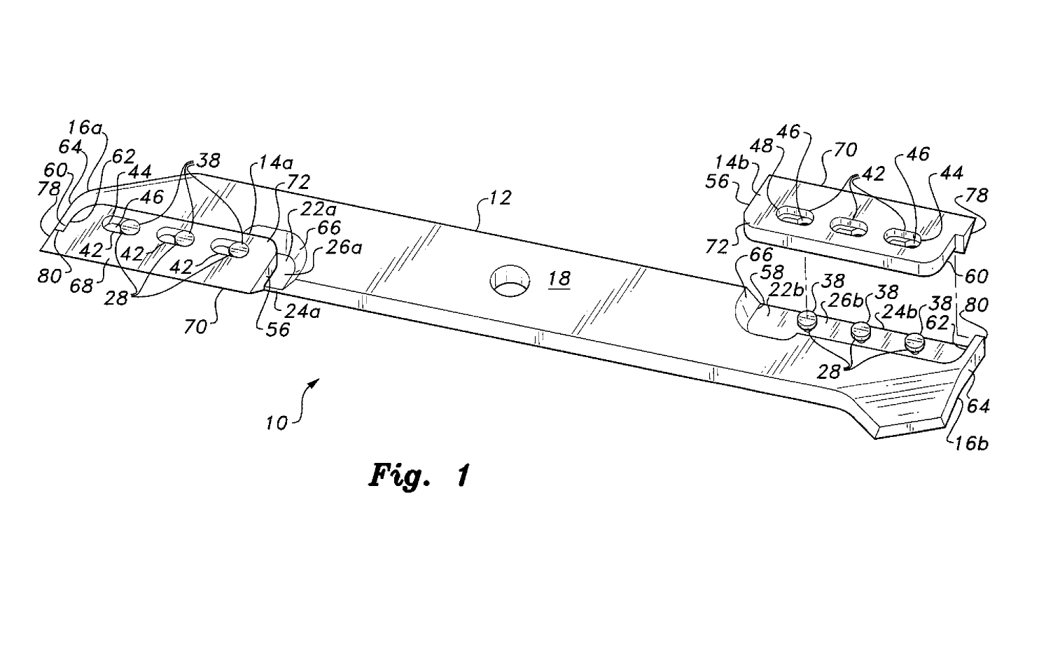

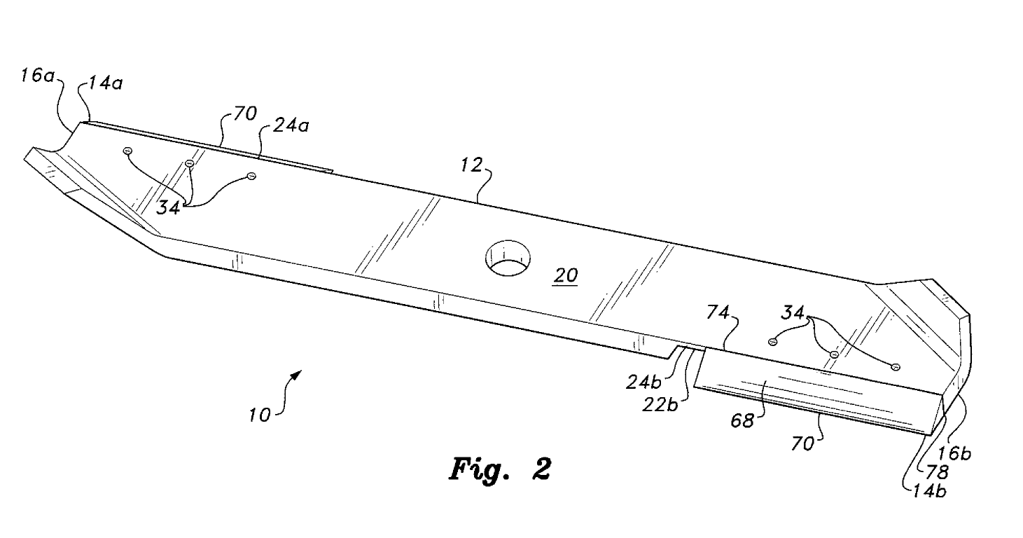

FIG. 1 of the drawings illustrates a bottom perspective view of the blade and insert assembly 10, and FIG. 2 provides a top perspective view of the assembly 10. The assembly 10 comprises a blade bar 12 having diametrically opposed, identical first and second cutting inserts 14 removably installed thereon. The second insert 14 is shown separated from the blade bar 12 in FIG. 1 to illustrate various structural details.

The blade bar 12 has identical, diametrically opposed first and second ends 16a and 16b, a lower surface 18, and an opposite upper surface 20. An insert relief 22a, 22b is formed in the lower surface 18 of the bar 12 adjacent each end 16a, 16b thereof The two insert reliefs 22a, 22b extend back from the respective leading edge portions 24a, 24b of the blade bar 12. Each relief 22a, 22b has a floor 26a, 26b. A plurality of insert attachment pins 28 extends upwardly from the floor 26a, 26b of each relief 22a, 22b.

Details of an exemplary pin 28 and its installation in one insert relief are shown in the elevation view in section of FIG. 5. It will be noted in the detail views of FIGS. 3, 4, and 5 that only a single end of the blade bar 12 and its associated components is illustrated. Accordingly, these components are designated by purely numerical reference characters without the addition of any alphabetic suffix, e.g., insert 14, blade bar end 16, insert relief 22, etc. It will be understood that due to the symmetry of the assembly 10 that FIGS. 3, 4, and 5 may represent either end 16a or 16b of the blade bar 12 and associated features.

The blade bar 12 has pin passages 30 extending through the thickness of the bar 12 along each of the insert reliefs 22. Each passage 30 has a frustoconical shape, including a smaller first diameter 32a at the floor 26 of the relief 22 and a slightly larger second diameter 32b at the upper surface 20 of the blade bar 12 opposite the relief 22. The shanks 34 of each of the pins 28 are swaged in place within their frustoconical passages 30, the shanks 34 expanding to fill the frustoconical volumes of the passages 30 to lock the pins 28 in place. Alternative pin attachment means may be provided if desired, e.g., welding the pins in place, threading the passages and shanks of the pins, etc.

The shank 34 of each pin 28 has a shoulder portion 36 serving as a stop when the pin is installed within its passage 30, and a distal head 38 spaced apart from the relief floor 26 by the thickness of the shoulder 36. The heads 38 have larger diameters than the shanks 34 and the shoulders 36, and serve to retain the corresponding cutting inserts 14 to the blade bar 12. Each of the heads 38 has a flat lower surface 40, i.e., the surface that is oriented downwardly when the blade bar 12 is installed on a mower for normal operation. The flat surfaces 40 of the heads 38 of the insert attachment pins 28 are coplanar with the lower or outer surfaces of the corresponding cutting inserts 14 when the inserts 14 are installed on the blade bar 12, as can be seen in the section view of FIG. 5, to preclude their being ground off upon a hard and/or rough surface during mowing operations.

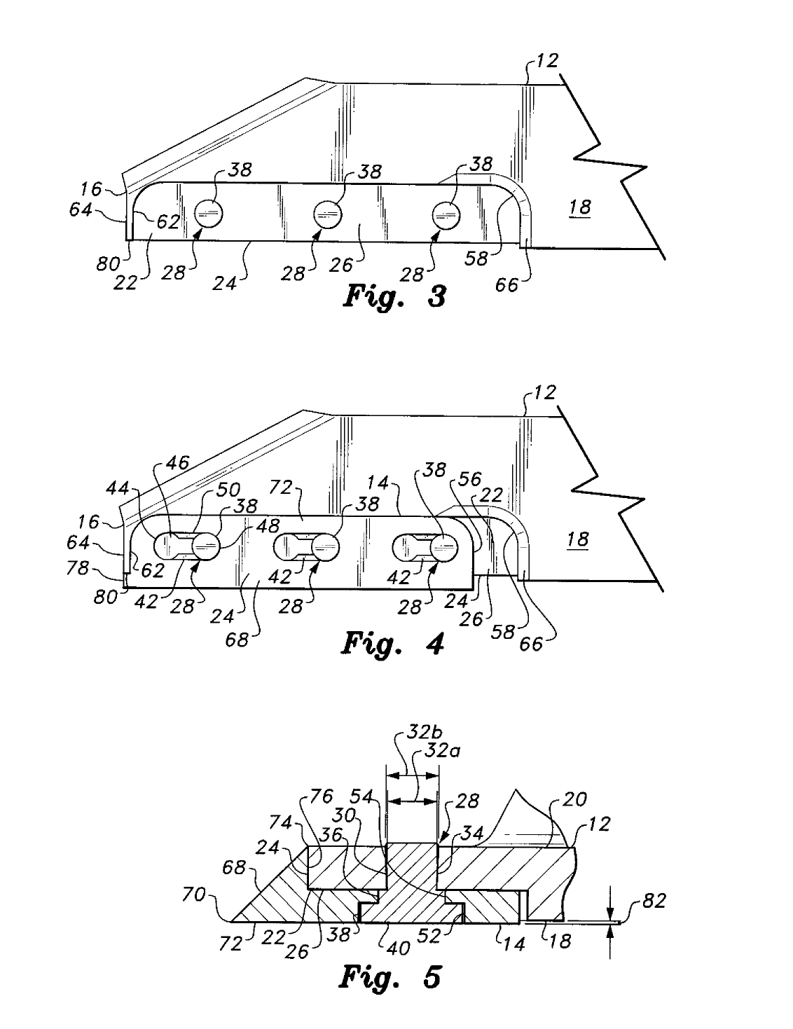

Each insert 14 has pin engagement slots 42 formed therethrough, corresponding in number and spacing to the insert attachment pins 28. Each of the slots 42 has an outer end 44, i.e., the end oriented toward the outer end 16 of the blade bar 12 when installed thereon, the outer end 44 of each slot 42 defining a pin head clearance passage 46 having a diameter closely matching that of the head 38 of the corresponding pin 28, as indicated in FIGS. 1 and 4 of the drawings. The opposite inboard end 48 and medial portion 50 of each slot 42 include relatively wide head clearance portions 52 adjacent the outer or lower surface of the insert 14 when installed on the blade bar 12, and narrower shank clearance portions 54 fitting closely about the shank of the pin 28, or more precisely about the shoulder portion 36 thereof when the insert 14 is installed, as shown in FIG. 5. In other words, each slot 42 has a keyhole shape and is recessed in the insert 14 so that the head 38 of the pin does not protrude below the surface of the insert 14 when the insert 14 is installed on the blade 10.

Each insert 14 is installed on the blade bar 12 by positioning the inner end 56 of the insert 14 immediately over the corresponding inner end 58 of its relief 22 to align the heads 38 of the pins 28 with the pin head passages 46 of the corresponding slots 42. The insert 14 is then positioned directly in contact with the floor 26 of the relief 22 and pushed outwardly, i.e., so that its outer end 60 is in direct contact with the outer end 62 of the relief 22. The tolerances of the mating components of the insert 14 and relief 22 and insert attachment pins 28 result in a force fit of the insert, in order to assure that the inserts 14 will remain in place during mower operation. The insert 14 may be tapped home against the insert stop 64 defining the outer end 62 of the relief 22, limiting further outward movement of the insert 14, the heads 38 of the pins 28 gripping the narrower shank clearance portions 54 of the slots 42 therebeneath to retain the inserts 14 securely in place within their reliefs 22 of the blade bar 12. The debris clearance bevel 66 provides access to the inboard end 56 of the insert 14 to tap it into position during installation, as well as providing a wide, tapered gap that does not tend to hold debris during mower operation.

It will be noted from the above description that most of the centrifugal forces developed by the cutting inserts 14 during mower operation are not applied to their insert attachment pins 28, but rather to the insert stops 64 at the outer ends 16 of the blade bar 12 via the outer ends 60 of the inserts. Similarly, the structure of the insert attachment to the blade bar 12 prevents significant application of force directly to the pins 28 during operation, as explained below. This greatly improves the durability and longevity of the attachment pins 28.

Each of the cutting inserts 14 has a cutting edge portion 68 extending forwardly in the direction of rotation of the blade bar 12 during operation of the mower. The cutting edge portion 68 has a sharpened cutting edge 70 coplanar with the lower surface 72 of the insert 14, the cutting edge portion 68 also sloping upwardly and rearwardly to an upper edge 74 coplanar with the upper surface 20 of the blade bar 12. The cutting edge portion 68 of each insert 14 has a rear face 76 that bears against the entirety of the leading edge portion 24 of the blade bar 12 that is contiguous with the rear face 76 when the insert 14 is installed on the blade bar 12.

The inserts 14 offer further protection for the blade bar 12 by means of an outer extension of each insert, comprising an outwardly stepped end portion 78 of the cutting edge portion 68 that bears against the leading end 80 of the corresponding insert stop 64 when the insert 14 is installed on the blade bar 12. In this manner, the inserts 14 transfer all impact forces to the leading edges 24 and the leading ends 80 of the insert stops of the blade bar 12, rather than subjecting the insert attachment pins 28 to such forces. This structure also has the advantage of protecting the surfaces of the leading edge portions 24 and insert stop leading ends 80 from damage, thereby assuring that they are not deformed and that their shapes or contours will conform to the corresponding features of the inserts 14 to be installed thereon to facilitate installation of the inserts. The very close tolerance fit between the rear face 76 of the cutting edge portion 68 of each insert 14 and the corresponding leading edge portion 24 of the blade bar 12, as well as a similar fit between the outwardly stepped end 78 of each insert and the corresponding leading end 80 of each insert stop 64, precludes the entry of all but insignificant amounts of debris therebetween, thus further facilitating the removal and installation of inserts 14 on the blade bar 12. Further protection of the blade bar 12 is provided by forming the inserts 14 such that they have a slightly greater thickness than the depth of the corresponding insert reliefs 22. This results in the lower or exposed surfaces 72 of the inserts 14 being slightly below the corresponding lower surfaces 18 of the blade bar 12, as can be seen by the insert to blade bar offset dimension 82 in FIG. 5. In this manner, the inserts 14 will take the brunt of any impact forces encountered and will tend to skim over obstacles or objects encountered so that the blade bar 12 is spared most such encounters due to the slightly raised lower surface 18 relative to the insert 14, as indicated by the dimension 82.

It is to be understood that the present invention is not limited to the embodiments described above, but encompasses any and all embodiments within the scope of the following claims.

1. A mower blade with replaceable inserts, comprising:
a blade bar having diametrically opposite first and second ends and a lower surface, the lower surface having an insert relief formed therein at at least one of the opposite ends of the blade bar, the blade bar has first and second leading edge portions corresponding to the first and second ends thereof, each of the leading edge portions define a continuous surface, and an upper surface opposite the lower surface;
a plurality of insert attachment pins extending from the at least one insert reliefs and fixedly attached thereto, each of the pins having a shank and a distal head, each of the heads having a flat upper surface, a lower surface, and a diameter larger than the corresponding shank; and
at least one cutting insert, the at least one cutting insert having a plurality of pin engagement slots defined therein, a lower surface, an inner end, an outer end opposite the inner end, and a sharpened cutting edge, each of the slots having an outer end defining a pin head clearance passage, and a medial portion and inner end defining a narrow shank clearance portion and a wide head clearance portion adjacent the lower surface of the insert, wherein at least the medial portion and inner end defining a stepped surface to receive the lower surface of the pin head, whereby the lower surface of the at least one cutting insert being coplanar with the flat surfaces of the heads of the corresponding pins when the cutting inserts are installed on the blade bar, the at least one cutting insert has a cutting edge portion, the sharpened cutting edge being disposed coplanar with the lower surface of the insert, the cutting edge portion further having an upwardly sloping face and a rear face, the rear face defining a continuous surface and having at least a portion thereof bearing against the corresponding continuous leading edge portion of the blade bar when the insert is installed thereon.

2. (canceled)

3. The mower blade with replaceable inserts according to claim 1, wherein:
the blade bar has an upper surface opposite the lower surface and a plurality of insert attachment pin passages defined therein along each said insert relief thereof, said insert relief further having a floor, each of the insert attachment pin passages having a frustoconical configuration having a first diameter adjacent the floor of the insert relief and a second diameter adjacent the upper surface of the blade bar, the second diameter being at least slightly larger than the first diameter; and
each of the insert attachment pins is secured within a corresponding one of the insert attachment pin passages, each of the pins having a shank swaged in place within the corresponding insert attachment pin passage and filling the passage.

4. The mower blade with replaceable inserts according to claim 1, wherein each said insert relief has an outer end and an insert stop disposed along the outer end.

5. The mower blade with replaceable inserts according to claim 4, wherein:
each of the insert stops has a leading end; and
each of the cutting inserts has an outwardly stepped end bearing against the leading end of the insert stop when the inserts are installed within corresponding reliefs of the blade bar.

6. The mower blade with replaceable inserts according to claim 1, wherein the inner end of each of the cutting insert reliefs of the blade bar has a debris clearance bevel.

7. The mower blade with replaceable inserts according to claim 1, wherein the lower surface of each of the cutting inserts is below the lower surface of the blade bar when the cutting inserts are installed thereon.

8-20. (canceled)

21. The mower blade with replaceable inserts according to claim 1, wherein the blade bar defines the lower surface having an insert relief formed therein at each of the opposite ends of the blade bar.

22. The mower blade with replaceable inserts according to claim 21, wherein there are two cutting inserts.
